(19) United States
(12) Patent Application Publication
(10) Pub. No.: US 2006/0061087 A1
(43) Pub. Date: Mar. 23, 2006

(54) Book cover, associated book, and method of manufacture

(76) Inventors: Christina M. Ericson, West Lake Village, CA (US); Eng Jei B. Litvack, Boca Raton, FL (US)

Correspondence Address: R. Neil Sudol, 714 Colorado Avenue, Bridgeport, CT, 06605-1601, US

(21) Appl. No.: 10/945,579

(22) Filed: Sep. 21, 2004

(51) Int. Cl. B42D 3/00

(52) U.S. Cl. 281/29

(57) ABSTRACT

A book cover in the form of a sheet having a plurality of folds each including at least a first panel and a second panel oriented at an angle with respect to one another. The first panels of the folds are provided with a first graphical pattern visualizable from a first direction with respect to the cover, while the second panels of the folds are provided with a second graphical pattern visualizable from a second direction with respect to the cover. The second direction is different from the first direction, and the second graphical pattern is different from the first graphical pattern. Preferably, coupling means are provided on the sheet for connecting the sheet to pages of a book.

### BACKGROUND OF THE INVENTION

This invention relates to a book cover. This invention also relates to a book provided with the book cover. This invention additionally relates to a method for manufacturing the book cover and the book.

Books are frequently provided with covers having features to draw attention to the books and provide entertainment. Such features include graphics and design, cutouts or windows, holographic images, fabric or leather material, three-dimensional objects that project from the plane of the cover, movable parts, etc. These features are particularly useful in the marketing of printed books and notebooks for children.

### OBJECTS OF THE INVENTION

It is an object of the invention to provide a book cover that has an enhanced sensual appeal.

More specifically, it is an object of the present invention to provide a book cover that has an enhanced visual appeal.

Another object of the present invention is to provide such a book cover that is easy to manufacture and assemble into a book.

A further object of the present invention is to provide such a book cover that is amenable to multifarious variation in visual aspect.

A related object of the present invention is to provide a book with a cover having an enhanced visual appeal.

Another related object of the present invention is to provide such a book that is easy to manufacture and assemble into a book.

A further relative object of the present invention is to provide such a book that can be provided with different graphical content, depending, for instance, on the subject matter, if any of the book.

Yet another object of the present invention is to provide a method of manufacturing such a book cover and related book.

These and other object of the present invention will be apparent from the drawings and descriptions herein. Although every object of the invention is believed to be attained by at least one object of the invention, there is not necessarily any single embodiment that achieves all of the objects of the invention.

### SUMMARY OF THE INVENTION

A book cover comprises, in accordance with the present invention, a sheet having a plurality of folds each including at least a first panel and a second panel oriented at an angle with respect to one another. The first panels of the folds are provided with a first graphical pattern visualizable from a first direction with respect to the cover, while the second panels of the folds are provided with a second graphical pattern visualizable from a second direction with respect to the cover. The second direction is different from the first direction, and the second graphical pattern is different from the first graphical pattern. Preferably, coupling means are provided on the sheet for connecting the sheet to pages of a book.

The graphical patterns on the cover may be photographs, abstract designs, graphical representations of figures such as cartoon characters, etc.

When one looks at the first panels from the one direction, with the cover located in a plane below eye level, one sees a composite image formed by the juxtaposition of image portions provided on the first panels. Similarly, when one views the second panels from a direction substantially opposite to the first direction, with the cover located in a plane below eye level, one sees a composite image formed by the juxtaposition of image portions provided on the second panels.

The image portions on the first panels may take the form of adjacent rectangular strips of a single preformed image or graphical design. On the cover sheet, the strips of that single preformed image are spaced from one another, by virtue of the interposed or interleaved second panels of the folds or pleats. Similarly, the image portions on the second panels may take the form of adjacent rectangular strips of a single preformed image or graphical design. On the cover sheet, the strips of that single preformed image are spaced from one another, by virtue of the interposed or interleaved first panels of the folds or pleats.

The coupling means may include a plurality of perforations in the sheet, along an edge thereof, and a spiral wire traversing the perforations. Alternatively, the coupling means may include, for example, an extension or special area to be glued to other parts of a book.

Pursuant to another feature of the present invention, the folds in the cover sheet are pleats, while the first panels and the second panels are elongate and planar areas that extend parallel to one another. The folds are thus a series of contiguous wedge-shaped or triangular ridges, concatenated to form an accordion-type panel or corrugation. Inadvertent flattening of this accordion-type structure or corrugation may be inhibited by providing a backing sheet to which opposite ends of the folded sheet are attached, e.g., glued. The width of the accordion-type or corrugated sheet is therefore determined by the width of the backing sheet. Although the individual folds may be flattened, the entire sheet cannot be stretched out to achieve that end result.

Preferably, the folded or pleated book cover sheet is made of a transparent polymeric material, the first graphical pattern and the second graphical pattern being printed on a back surface of the sheet.

Pursuant to a further feature of the present invention, the book cover sheet is vacuum molded polymeric material. Where the folds in the cover sheet particularly take the form of contiguous wedge-shaped or triangular ridges, concatenated to form an accordion-type panel or corrugation, a blank in the form of a planar sheet of the polymeric material is vacuum molded on a mold having a triangular ridged structure.

A book pursuant to the present invention comprises the above-described cover together with a plurality of pages bound to the cover by binding or coupling means A method for forming a book cover comprises, in accordance with the present invention, providing a sheet of polymeric material, vacuum molding the sheet in a predetermined configuration, and providing the sheet with at least two different graphical patterns visualizable from respective different directions relative to the vacuum-molded sheet.

The providing of the sheet with the different graphical patterns preferably, but not necessarily, includes printing the graphical patterns on a back or bottom side of the sheet. In that case the sheet is made of a transparent polymeric material and the printing of the graphical patterns is performed prior to the vacuum molding of the sheet.

The method may additionally comprise die cutting the vacuum molded sheets with the graphical patterns into pre-assembly pieces and coupling the pieces to pages of a book.

### BRIEF DESCRIPTION OF THE DRAWINGS

FIG. 1 is a perspective view of a pleated book cover in accordance with the present invention, showing multiple elongate folds each having two rectangular panels.

FIG. 2 is an elevational view of the book cover of FIG. 1.

FIG. 3 is a top plan view of a particular embodiment of a book cover in accordance with the present invention, showing adjacent panels provided with portions of two different graphical patterns, every other panel bearing a portion of the same graphical pattern.

FIG. 4 is a top plan view similar to FIG. 3, showing the image portions on only odd-numbered panels.

FIG. 5 is a top plan view similar to FIG. 4, showing the image portions on only the even numbered panels.

### DETAILED DESCRIPTION OF THE PREFERRED EMBODIMENTS

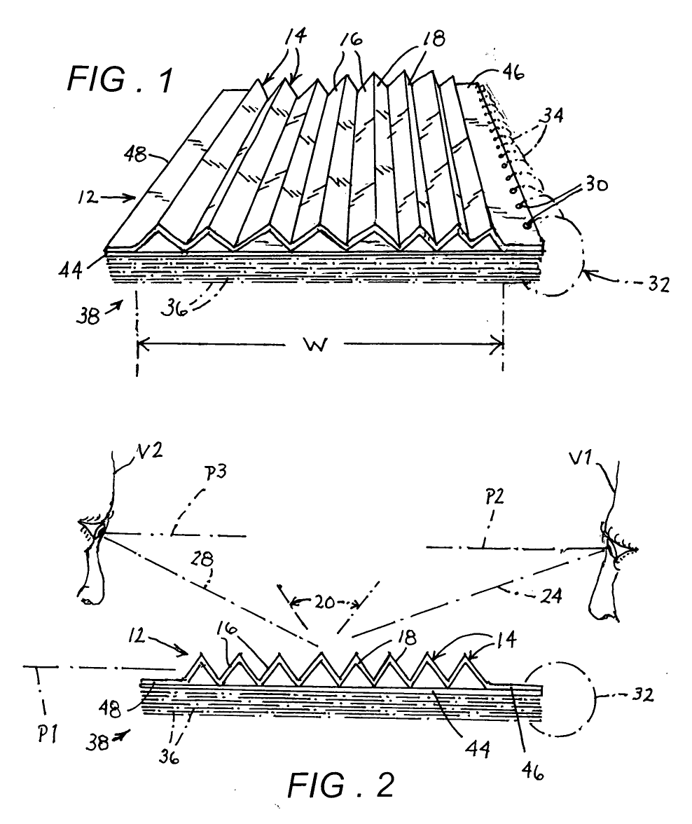

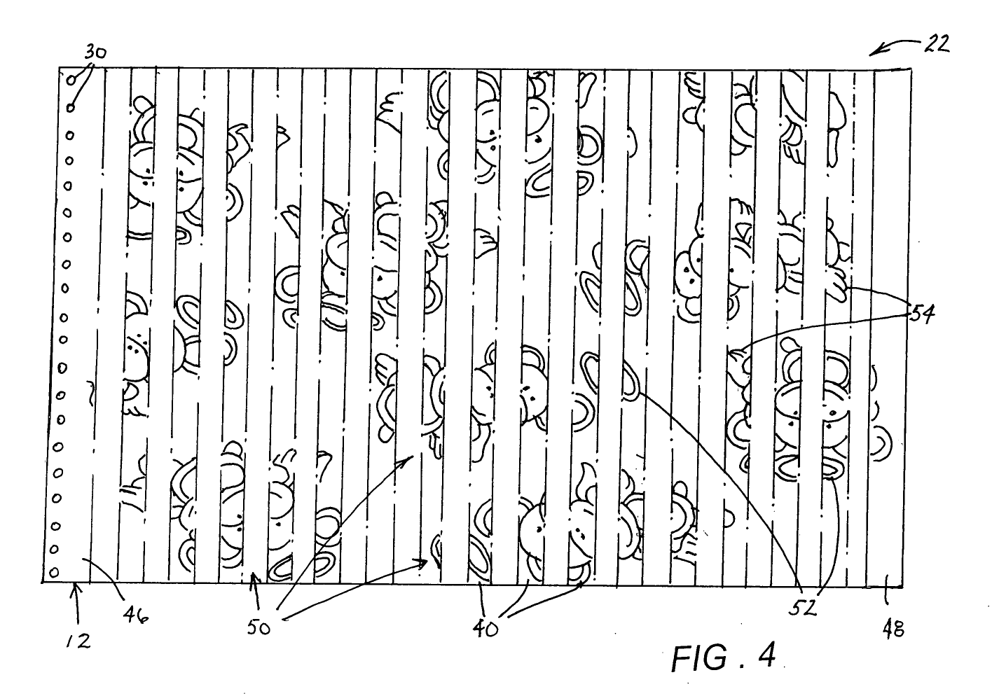

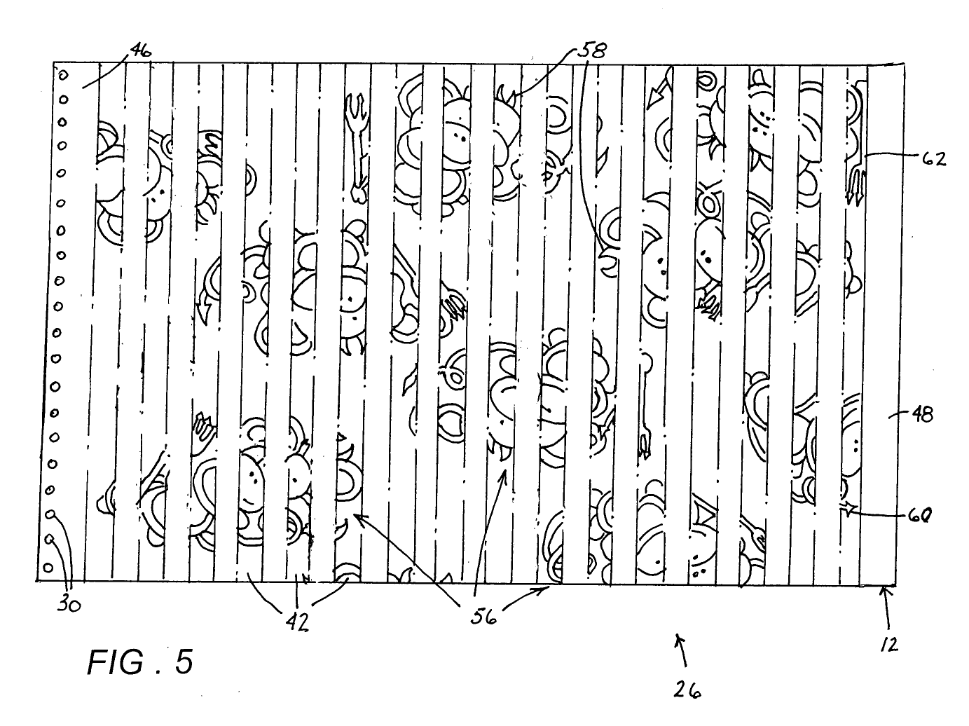

As depicted in the drawings, a book cover 12 comprises a sheet formed to have a plurality of folds or pleats 14. Each fold or pleat 14 includes a first panel 16 and a second panel 18 oriented at an angle 20 with respect to one another. The first panels 16 of folds or pleats 14 are provided with a first graphical pattern 22 (see FIG. 4) that is visualizable from a first direction 24 (FIG. 2) with respect to cover 12. The second panels 18 of folds 14 are provided with a second graphical pattern 26 (see FIG. 5) that is visualizable from a second direction 28 (FIG. 2) with respect to cover 12. Directions 24 and 28 are different enough from one another that a viewer will essentially see the image portions on only one set of panels 16 or 18, the other set of panels 18 or 16 being essentially invisible from the respective viewing direction 24, 28.

Graphical patterns 22 and 26 are preferably different from one another so that a person has a different visual impression viewing the two images. The difference between patterns 22 and 26 may be small. For instance, patterns 22 and 26 may be reproductions of the same photographic image, using a different color filter. Alternatively, patterns 22 and 26 may be the same graphical representation reproduced as mirror images. In any event, there is preferably a difference in visual appearance that may be appreciated by viewing cover 12 from directions 24 and 28, respectively.

Sheet 12 is provided with coupling elements in the form of a linear array of equispaced perforations 30 and a spiral binding wire 32. Perforations 30 are traversed by respective windings or turns 34 of wire 32. Wire 32 connects cover 12 to pages 36 of a book 38. Pages 36 may be printed with graphical and/or textual material. Alternatively, pages 36 may be blank, book 38 being a notebook or writing pad.

The graphical patterns 22 and 26 on cover 12 may take virtually any visually perceptible form. Patterns 22 and 26 may be photographs, abstract designs, graphical representations of human figures or animals such as cartoon characters, etc. Patterns 22 and 26 may be line drawings or logos or messages consisting of alphanumeric characters.

When a viewer V1 (FIG. 2) looks at panels 18 from direction 24, with cover 12 located in a plane P1 below eye level P2, viewer V1 sees a composite image formed by the juxtaposition of portions 40 of graphical pattern 22 provided on panels 18. Similarly, when a viewer V2 looks at panels 16 from direction 28, substantially opposite to direction 24, with cover 12 located in plane P1 below eye level P3, one sees a composite image formed by the juxtaposition of image portions 42 of graphical pattern 26 provided on panels 16.

Image portions 40 on panels 16 take the form of adjacent rectangular strips (not separately designated) of a single preformed image or graphical design 22. On cover sheet 12, image portions or strips 40 are spaced from one another, by virtue of the interposed or interleaved panels 18 of folds or pleats 14. Similarly, image portions 42 on panels 18 take the form of adjacent rectangular strips (not separately designated) of a single preformed image or graphical design 26. On cover sheet 12, image portions or strips 42 of that single preformed image 26.are spaced from one another, by virtue of the interposed or interleaved panels 16 of folds or pleats 14.

Panels 16 and 18 are elongate planar elements that extend parallel to one another. Folds or pleats 14 are a series of contiguous wedge-shaped or triangular ridges (not separately designated), concatenated to form an accordion-type structure or corrugation (not separately designated). Inadvertent flattening of this accordion-type structure or corrugation may be inhibited by providing a backing sheet 44 to which opposite ends 46 and 48 of cover sheet 12 are attached, e.g., glued. The width W of accordion-type or corrugated sheet 12 is therefore determined by the width of backing sheet 44. Although the individual folds 14 may be flattened, the entire sheet 12 cannot be stretched out to achieve that end result.

Preferably, cover sheet 12 is made of a transparent polymeric material such as polyvinyl chloride (PVC) that is vacuum formed or molded on corrugated shaping tools (not illustrated) having a triangular ridged structure. The PVC sheet material is “reverse” printed with interleaved portions 40 and 42 of graphical patterns 22 and 26 so that cover sheet 12 is smooth and shiny on an upper side. Typically, segmented patterns 22 and 26 are printed on the reverse or back side of sheet 12 prior to the vacuum molding thereof to form folds or pleats 14. Subsequently, the vacuum molded sheets 12 with the segmented graphical patterns 22 and 26 are die cut into pre-assembly pieces (FIGS. 1 and 2) and coupled by wire spiral 32 to pages 36 to form book 38.

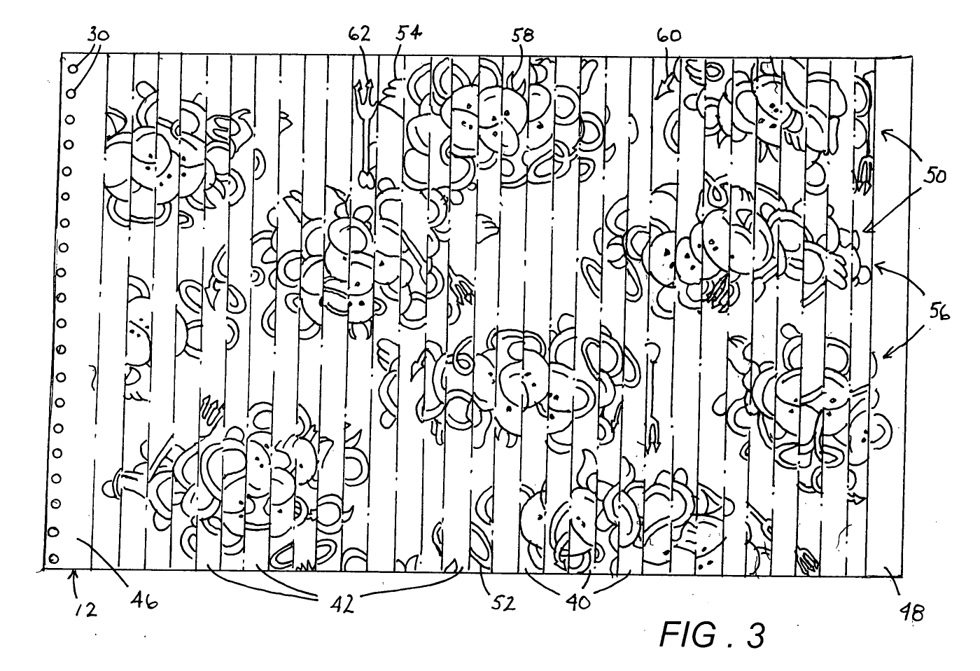

As depicted in FIGS. 3 and 4, pattern 22 may include a plurality of line drawings of “angel” monkeys 50 having haloes 52 and wings 54. As depicted in FIGS. 3 and 5, pattern 26 may include a plurality of line drawings of “devil” monkeys 56 having horns 58, barbed tails 60, and pitchforks 62. Monkeys 50 and 56 are disposed in different orientations in different locations about cover sheet 16.

Although the invention has been described in terms of particular embodiments and applications, one of ordinary skill in the art, in light of this teaching, can generate additional embodiments and modifications without departing from the spirit of or exceeding the scope of the claimed invention. For instance, it is possible for graphical patterns 22 and 26 to be the same image. In some instances, that difference may be enough to afford some entertainment and novelty value to the cover 12. A viewer will have a different impression of the image viewed from direction 24 or 28, on the one hand, and from the top or straight on.

Cover 12 may be bound or connected to the pages of a book by any known technique, including stapling, gluing, sewing, tacking, clamping, and clipping.

Accordingly, it is to be understood that the drawings and descriptions herein are proffered by way of example to facilitate comprehension of the invention and should not be construed to limit the scope thereof.

What is claimed is:

1. A book cover comprising:
a sheet having a plurality of folds each including at least a first panel and a second panel oriented at an angle with respect to one another, the first panels of said folds being provided with a first graphical pattern visualizable from a first direction with respect to said cover, said second panels of said folds being provided with a second graphical pattern visualizable from a second direction with respect to said cover, said second direction being different from said first direction, said second graphical pattern being different from said first graphical pattern; and
coupling means on said sheet for connecting said sheet to pages of a book.

2. The book cover defined in claim 1 wherein said coupling means includes a plurality of perforations in said sheet, along an edge thereof.

3. The book cover defined in claim 2 wherein said coupling means further includes a spiral wire traversing said perforations.

4. The book cover defined in claim 1 wherein said first panels and said second panels are elongate and planar, said first panels and said second panels extending parallel to one another.

5. The book cover defined in claim 1 wherein said sheet is made of a transparent polymeric material, said first graphical pattern and said second graphical pattern being printed on a back surface of said sheet.

6. The book cover defined in claim 1 wherein said sheet is vacuum molded polymeric material.

7. The book cover defined in claim 1 wherein said folds form triangular corrugations.

8. A book comprising:
a plurality of pages;
binding means attached to said pages for binding said pages to one another in a book format; and
a cover sheet coupled to said pages,
said cover sheet having a plurality of folds each including at least a first panel and a second panel oriented at an angle with respect to one another,
the first panels of said folds being provided with a first graphical pattern visualizable from a first direction relative to said cover,
said second panels of said folds being provided with a second graphical pattern visualizable from a second direction relative to said cover,
said second direction being different from said first direction,
said second graphical pattern being different from said first graphical pattern.

9. The book defined in claim 8 wherein said cover is coupled to said pages via said binding means.

10. The book defined in claim 9 wherein said binding means includes a spiral wire traversing perforations in said sheet and said pages.

11. The book defined in claims 8 wherein said first panels and said panels are elongate and planar, said first panels and said second panels extending parallel to one another.

12. The book defined in claims 8 wherein said sheet is made of a transparent polymeric material, said first graphical pattern and said second graphical pattern being printed on a back surface of said sheet.

13. The book defined in claims 8 wherein said sheet is vacuum molded polymeric material.

14. The book defined in claims 8 wherein said folds form triangular corrugations.

15. A method for forming a book cover comprising:
providing a sheet of polymeric material;
vacuum molding said sheet in a predetermined configuration; and
providing said sheet with at least two different graphical patterns visualizable from respective different directions relative to the vacuum-molded sheet.

16. The method defined in claim 15 wherein the providing of said sheet with said different graphical patterns includes printing said graphical patterns on a back or bottom side of said sheet.

17. The method defined in claim 16 wherein the printing of said graphical patterns is performed prior to the vacuum molding of said sheet.

18. The method defined in claim 15 wherein said predetermined configuration is an accordion-type configuration of multiple parallel folds.

19. The method defined in claim 15, further comprising die cutting the vacuum molded sheets with the graphical patterns into pre-assembly pieces and coupling said pieces to pages of a book.
